(19) United States
(12) Patent Application Publication
(10) Pub. No.: US 2008/0089625 A1
(43) Pub. Date: Apr. 17, 2008

(54) Fluid dynamic bearing system

(76) Inventors: Martin Engesser, Donaueschingen (DE); Stefan Schwamberger, Hermsdorf (DE)

Correspondence Address: COOPER & DUNHAM, LLP, 1185 AVENUE OF THE AMERICAS, NEW YORK, NY, 10036, US

(21) Appl. No.: 11/974,308

(22) Filed: Oct. 12, 2007

(30) Foreign Application Priority Data
Oct. 17, 2006 (DE) 10 2006 048 895.4

(51) Int. Cl. F16C 17/10

(52) U.S. Cl. 384/110

(57) ABSTRACT

The invention relates to a fluid dynamic bearing system used in particular for the rotational support of spindle motors for driving the storage disks in hard disk drives having a stationary bearing part (10, 16, 20) and a rotating bearing part (12, 14), wherein the bearing parts are separated from one another by a bearing gap (18) filled with bearing fluid and rotatable with respect to each other about a rotational axis (36), wherein at least one radial bearing (28; 30) is provided in a first section (18′) of the bearing gap and at least one axial bearing (32; 34) is provided in a second section (18″) of the bearing gap, and a supply volume (22) for the bearing fluid connected to the bearing gap (18) is provided. According to the invention, it is provided that the supply volume (22) is formed at the outside circumference of the stationary bearing part and that it is connected via a connecting channel (37) to the second section (18″) of the bearing gap.

### BACKGROUND OF THE INVENTION

The invention relates to a fluid dynamic bearing system used in particular for the rotational support of a spindle motor for driving the storage disks of a hard disk drive according to the characteristics outlined in the preamble of claim 1.

### DESCRIPTION OF THE PRIOR ART

In a fluid dynamic bearing, a rotating bearing part, such as a cylindrical shaft, is rotatably supported within a bore in a stationary bearing part, such as a bearing bush. The inside diameter of the bore is slightly larger than the outside diameter of the shaft, so that a thin bearing gap is formed between the sleeve surfaces of the bore and the shaft, the bearing gap being filled with a bearing fluid, preferably with oil. The bearing bush is commonly held in a bearing receiving portion. In order to build up fluid dynamic pressure in the bearing gap, at least one of the bearing surfaces of the shaft or of the bearing bush is provided with a surface pattern. Due to the relative rotational movement between the opposing sleeve surfaces or bearing surfaces, a kind of pumping effect is exerted on the bearing fluid, allowing the creation of a uniformly thick and homogeneous lubricant that separates the bearing surfaces from one another and which is stabilized by zones of fluid dynamic pressure. The advantages of this basic fluid dynamic bearing principle over roller bearings for the purpose of rotationally supporting a shaft include a low noise level, improved running precision and significantly higher shock resistance. In addition, fewer parts are needed thus leading to a considerable reduction in the costs of manufacture.

One disadvantage of fluid dynamic bearing systems is that the oil used in the fluid dynamic bearings evaporates over time. This means that the bearings have to hold a sufficient supply of fluid to last them for their specified useful life. The higher the expected operating temperature of the bearing and the longer the required useful life, the greater the fluid supply needs to be.

Another factor influencing the evaporation rate of the bearing fluid is the size of the contact surface of the fluid to the surrounding air. A smaller surface reduces fluid loss over time. If the fluid in the supply volume can move, for example, due to rotating parts being placed adjacent to the supply volume, this goes to increase the contact surface and thus the evaporation rate as well.

No less crucial for the evaporation rate, is the state of the surrounding air. If the contact surface is surrounded by moving air, the evaporation rate is greater than for a contact surface that adjoins a non-moving air volume which is already enriched by fluid vapor.

If a long useful life is required for a fluid dynamic bearing operating at high temperatures, the following requirements regarding the fluid supply have to be met:
a) Large supply volume
b) Lowest possible temperature for the supply volume
c) Small contact surfaces to the surrounding air
d) Non-moving air at the contact surface
e) Surrounding air enriched with fluid vapors (low air exchange with the surroundings)
f) No significant fluid movement in the fluid supply

### SUMMARY OF THE INVENTION

The object of the invention is to provide a fluid dynamic bearing system which best satisfies the criteria listed above.

This object has been achieved according to the invention by a fluid dynamic bearing system according to independent claim 1.

Beneficial embodiments and characteristics of the invention can be derived from the subordinate claims.

According to the invention, the supply volume is formed at the outside circumference of the stationary bearing part and connected via a connecting channel to the second, lower section of the bearing gap.

The stationary bearing part of the bearing system according to the invention comprises a bearing bush that is accommodated in a stationary sleeve, an opening of the bearing bush being sealed by a cover plate. The rotating bearing part, on the other hand, comprises a shaft that is rotatably supported in a bore of the bearing bush, a thrust plate being disposed at one end of the shaft.

An alternative embodiment of the invention can provide a shaft as the stationary bearing part, the shaft being enclosed by a rotating bearing bush. Here, the supply volume can be provided at the outside circumference of the rotating bearing bush.

In a preferred embodiment of the invention, the supply volume extends in an axial direction over a large part of the outside circumferences of the stationary bearing part, in particular annularly about the outside circumference of the bearing bush, the supply volume being enclosed between the bearing bush and the sleeve. The supply volume is preferably formed by a tapered recess at the outside circumference of the bearing bush or respectively at the inside circumference of the sleeve. The supply volume is at least partly filled with bearing fluid, the end having the smallest cross-section running into the connecting channel.

The sleeve has an opening that runs into the wider end of the supply volume and connects this end to the outside atmosphere.

To seal the bearing gap in the region of its first section, i.e. where the shaft emerges from the bearing bush, a conical capillary seal may be provided. However, the gap may also be sealed by a groove in the shaft or in the bearing bush, the groove acting as a fluid barrier. As an alternative or in addition, the bearing gap may be sealed by a pumping seal that exerts a pumping effect on the bearing fluid.

The thrust plate is disposed in a conventional way in a recess in the bearing bush and enclosed by the second section of the bearing gap. The surfaces of the thrust plate together with a respective opposing surface of the bearing bush and/or cover plate form at least one axial bearing.

According to the invention, the first section of the bearing gap has a first radial bearing that generates a pumping effect on the bearing fluid in the direction of the second section of the bearing gap.

Moreover, the first section of the bearing gap can have a second radial bearing spaced apart from the first radial bearing, the second radial bearing likewise generating a pumping effect on the bearing fluid.

The design and construction of the bearing according to the invention makes it possible to achieve a range of advantages, which, in particular, also fulfill the requirements mentioned in the introductory part of the description.

a) For rotationally symmetric components, a large volume can be achieved by disposing the fluid supply in areas having large diameters. The fluid supply should thus be located at the outermost part of the bearing system possible.

b) Disposing the fluid supply close to the outside diameter also takes account of the second requirement. Components that are located far away from the effective fluid dynamic bearing surfaces are less affected by any self-heating of the bearing system due to bearing friction.

c) At first glance, the requirement for a small contact surface to the surrounding air contradicts the first requirement for a large fluid supply volume. In constructional terms, however, this requirement can be fulfilled. For example, using a conical seal for the fluid supply, also called a taper seal, both requirements can be made to accord with one another by providing a small aperture angle and a long length.

d) To ensure that the air at the contact surface is motionless, no rotating parts may be located in the vicinity of the contact surface or these parts have to be shielded from the motionless air by components.

e) Through the evaporated fluid, the air in the area surrounding the contact surface is enriched with fluid vapors. If this air is not removed, or removed only very slowly, the evaporation rate falls. Thus the air around the contact surface not only needs to be still, but should be sealed as well as possible vis-à-vis the environment. The channel to the environment needed for purposes of pressure equalization should be designed with a correspondingly small cross-section.

f) Should the fluid supply adjoin a rotating surface, or should there be a flow in the fluid supply, the contact surface will thus be increased due to wave formation and due to the effects of the centrifugal force. This enlarged surface will in turn lead to greater evaporation rates and should be avoided.

The inner bearings (axial bearings and lower, second radial bearing) are designed such that the fluid is always pumped in the direction of the upper, first radial bearing. The connecting channels in the lower region of the bearing allow the required fluid to continue to flow from the fluid supply into the bearing gap. The upper branch of the upper, first radial bearing is able to build up counter-pressure to the inner bearings so that the column of fluid never reaches the upper end of the bearing gap during operation (pumping seal function). This additionally goes to ensure that the inner bearing pressure is always higher than the ambient pressure.

Due to the high pressure generated by the bearings, the shock resistance in operation is excellent. These pressures have to be overcome in order to force fluid out of the bearing. Shock resistance in an axial direction when the bearing is at a standstill is ensured by the resulting low height of the column of fluid. When there is a shock from below, the column of fluid in the bearing gap at the most falls to the level of the fluid supply. When the bearing is next in operation, the bearing gap fills up again. With a shock from above, the fluid is held perfectly well in the narrow bearing gap due to the capillary effect.

Should recirculation through the bearing be required, the channel provided for this purpose must always lie below both possible columns of fluid (in the bearing gap or respectively in the fluid supply). If not, the air which would otherwise be found in the channel could be drawn into the bearing gap as an air bubble.

Furthermore, a conical capillary seal above the first radial bearing may be omitted thus leading to improved bearing performance due to the greater mutual distance between the radial bearings. In this case, a groove may be provided in the shaft and/or the bearing bush above the upper, first radial bearing.

In order to fill the bearing with fluid (oil), either the shaft exit is sealed and the bearing fluid is filled in from one end under vacuum, or the bearing fluid is injected from one end until it approaches the sealing point at the upper end of the bearing.

### BRIEF DESCRIPTION OF THE DRAWINGS

FIG. 1 shows a first embodiment of a fluid dynamic bearing according to the invention.

FIG. 2 shows a second embodiment of a fluid dynamic bearing according to the invention having a recirculation channel.

FIG. 3 shows a third embodiment of a fluid dynamic bearing according to the invention also having a recirculation channel.

### DESCRIPTION OF PREFERRED EMBODIMENTS OF THE INVENTION

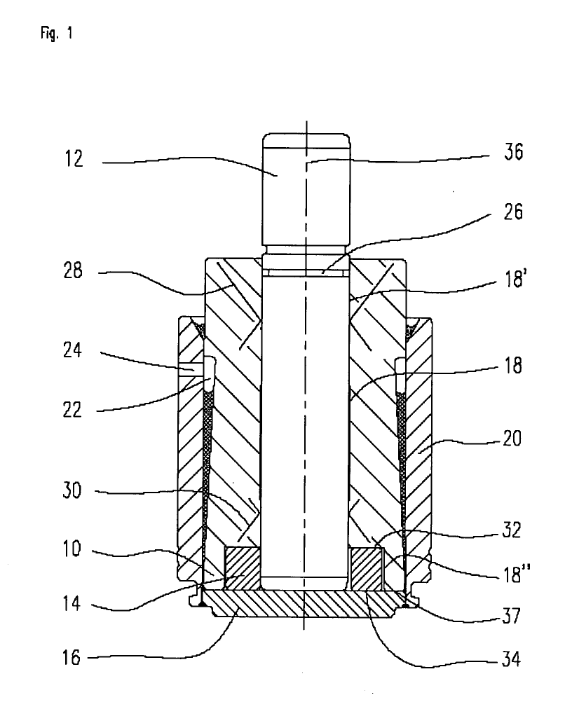

FIG. 1 shows a first embodiment of the bearing according to the invention. The bearing comprises a stationary bearing sleeve 10 that is held in an enclosing sleeve 20. The sleeve in turn may be held, for example, in a housing flange (not illustrated). The bearing bush 10 has a central bore in which a shaft 12 is rotatably supported. The bearing bush 10 is sealed at one end by a cover plate 16, whereas at the other end the shaft 12 projects beyond the bearing bush 10. The shaft is preferably supported radially by two radial bearings 28 and 30 that are disposed at a mutual distance. The radial bearings 28, 30 are defined in a conventional way by appropriate bearing patterns that are provided on the surface of the shaft 12 and/or of the bearing bush 10. On rotation of the shaft 12 in the bearing bush 10, the bearing patterns generate a pumping effect on the bearing fluid, thus giving the fluid bearing its load-carrying capacity. To support the shaft 12 axially, a thrust plate 14 is provided which is fixed in the shaft 12. The thrust plate is loosely accommodated in a recess in the bearing bush 10 and rotates together with the shaft 12. One of the end faces of the thrust plate 14 lies opposite a corresponding surface of the bearing bush 10 and the other opposite a corresponding surface of the cover plate 16. Bearing patterns are likewise provided on these bearing surfaces in a conventional way, the bearing patterns defining a first axial bearing 32 and preferably also a second axial bearing 34.

The bearing gap 18 that separates the stationary part of the bearing from the rotating part extends in its first section 18′ over the entire length of the shaft and in a second section 18″ around the thrust plate and is filled with a bearing fluid, preferably bearing oil.

The bearing gap is preferably sealed in the region of the free end of the shaft via a groove 26 that acts as a fluid brake and prevents bearing fluid from leaking from the bearing gap 18.

According to the invention, a recess is now provided at the outside circumference of the bearing bush 10, the recess being approximately triangular in cross-section and tapering to narrow in the direction of the cover plate 16. This recess is enclosed by the sleeve 20, so that a supply volume 22 is created between the bearing bush 10 and the sleeve 20, the supply volume being at least partly filled with bearing fluid. The supply volume 22 is connected at its narrow end to the second section 18″ of the bearing gap via a connecting channel 37. This means that an exchange of bearing fluid can take place between the bearing gap 18 and the supply volume 22. An opening 24 in the sleeve 20 that ends in an upper region of the supply volume 22 is used to equalize the pressure in the supply volume.

The first, upper radial bearing 28 comprises bearing patterns that are designed such that they generate a pumping effect on the bearing fluid in the direction of the thrust plate 14. In contrast, the second, lower radial bearing 30 generates a pumping effect in the direction of the first radial bearing 28. In this way, the pressure is equalized in the first section 18′ of the bearing gap. Via the connecting channel 37 in the lower region of the bearing, bearing fluid can be re-supplied from the supply volume when required.

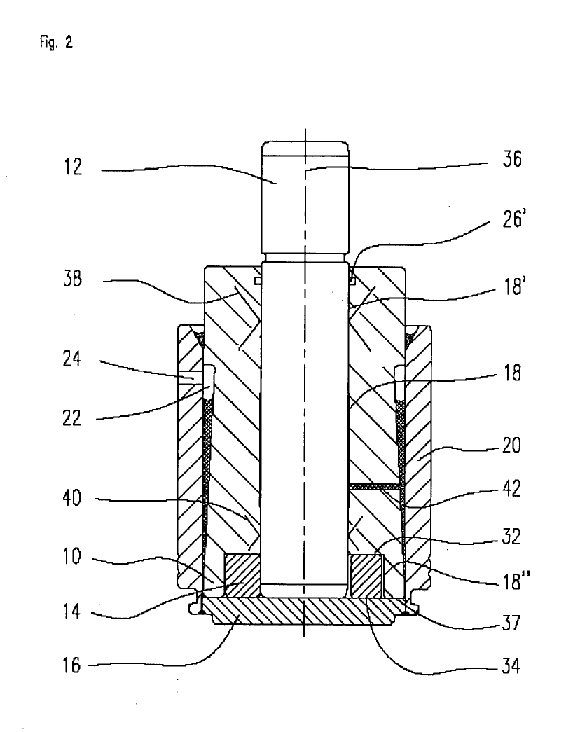

FIG. 2 shows a second embodiment of a fluid bearing according to the invention. The construction of the bearing in FIG. 2 substantially corresponds to the construction of the bearing in FIG. 1, identical components being indicated by the same reference numbers. In contrast to FIG. 1, the groove 26′ is disposed in the sleeve 10 instead of in the shaft.

A substantial difference between the fluid bearing according to FIG. 2 and the bearing according to FIG. 1 lies in the fact that at least one recirculation channel 42 is provided in the bearing bush 10, the recirculation channel connecting the section of the supply volume 22 filled with bearing fluid to the first section 18′ of the bearing gap 18. The first radial bearing 38 still generates a pumping effect in the direction of the second radial bearing 40 or the thrust plate 14 respectively. In contrast to FIG. 1, here the second axial bearing 40 also generates a pumping effect in the direction of the thrust plate 14, so that bearing fluid is pumped via section 18″ of the bearing gap and the connecting channel 37 into the supply volume 22 and further via the recirculation channel 42 again into the first section 18′ of the bearing gap, thus creating a closed fluid circuit.

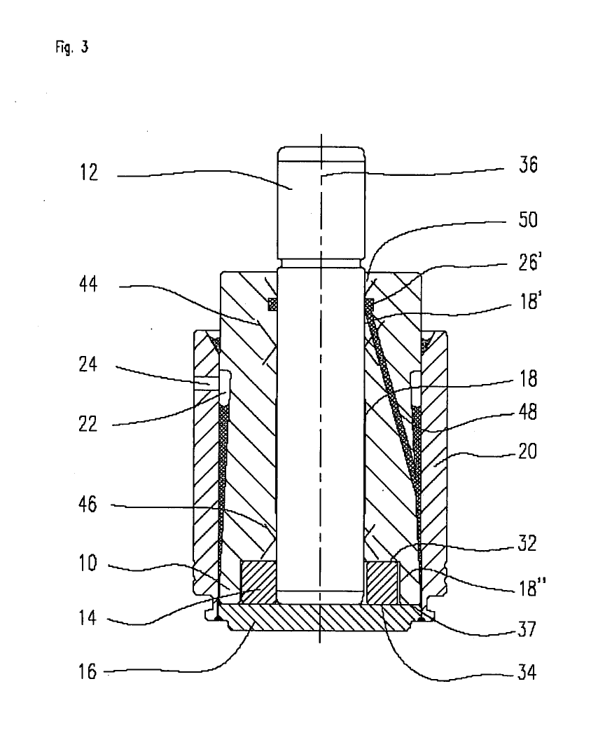

FIG. 3 shows a third embodiment of the bearing according to the invention whose essential construction also corresponds to the bearing described in FIG. 1. Here again, identical components are indicated by the same reference numbers.

In contrast to FIGS. 1 and 2 the bearing according to FIG. 3 comprises a recirculation channel that connects a section of the supply volume 22 filled with bearing fluid directly to a groove 26′ provided in the bearing bush 10. The groove 26′ is used to seal the bearing gap 18 and is supported by pumping patterns 50 provided at the end of the bearing gap 18, the pumping patterns pumping any bearing fluid escaping from the groove back into the region of the groove 26′.

The upper radial bearing 44 likewise generates a pumping effect mainly in the direction of the thrust plate 14, whereas the lower radial bearing 46 generates a pumping effect in the direction of the first upper radial bearing 44. Bearing fluid can flow from the groove 26′ back into the supply volume 22 via the recirculation channel 48.

In all three of the described embodiments according to FIGS. 1 to 3 a relatively large supply volume 22 is provided. By disposing the supply volume at the largest circumference of the bearing bush 10, a very large volume can be achieved with relative ease, the volume being preferably substantially larger than the quantity of bearing fluid found in the bearing gap. This makes possible a long useful life of the bearing according to the invention, even at high operating temperatures since evaporated bearing fluid can be replaced over a long period of time from the fluid supply found in the supply volume.

### IDENTIFICATION REFERENCE LIST

10 Bearing bush
12 Shaft
14 Thrust plate
16 Cover plate
18 Bearing gap
18′ First section of the bearing gap
18″ Second section of the bearing gap
20 Sleeve
22 Supply volume
24 Opening (of the sleeve)
26 Groove (shaft)
26′ Groove (sleeve)
28 Radial bearing
30 Radial bearing
32 Axial bearing
34 Axial bearing
36 Rotational axis
37 Connecting channel
38 Radial bearing
40 Radial bearing
42 Recirculation channel
44 Radial bearing
46 Radial bearing
48 Recirculation channel
50 Pumping patterns (pumping seal)

1. A fluid dynamic bearing system, used in particular for the rotational support of spindle motors for driving the storage disks in hard disk drives having a stationary bearing part (10, 16, 20) and a rotating bearing part (12, 14), wherein the bearing parts are separated from one another by a bearing gap (18) filled with bearing fluid and rotatable with respect to each other about a rotational axis (36), wherein at least one radial bearing (28; 30) is provided in a first section (18′) of the bearing gap and at least one axial bearing (32; 34) is provided in a second section (18″) of the bearing gap, and a supply volume (22) for the bearing fluid connected to the bearing gap (18) is provided,
characterized in that,
the supply volume (22) is formed at the outside circumference of the stationary bearing part and that it is connected via a connecting channel (37) to the second section (18″) of the bearing gap.

2. A fluid dynamic bearing system according to claim 1, characterized in that the stationary bearing part comprises a bearing bush (10) that is accommodated in a stationary sleeve (20), an opening of the bearing bush being sealed by a cover plate (16).

3. A fluid dynamic bearing system according to claim 1, characterized in that the rotating bearing part comprises a shaft (12) and a thrust plate (14) disposed at one end of the shaft.

4. A fluid dynamic bearing system according to claim 2, characterized in that the supply volume (22) extends in an axial direction over a large part of the outside circumference of the bearing bush (10).

5. A fluid dynamic bearing system according to claim 1, characterized in that the supply volume (22) is annular in shape.

6. A fluid dynamic bearing system according to claim 1, characterized in that the supply volume (22) is at least partly filled with bearing fluid.

7. A fluid dynamic bearing system according to claim 1, characterized in that the cross-section of the supply volume (22) is substantially triangular in shape, the end having the smaller cross-section being connected to the connecting channel (37).

8. A fluid dynamic bearing system according to claim 1, characterized in that the cross-section of the supply volume (22) is substantially rectangular in shape.

9. A fluid dynamic bearing system according to claim 2, characterized in that the sleeve (20) has an opening (24) that connects the supply volume (22) to the outside atmosphere.

10. A fluid dynamic bearing system according to claim 1, characterized in that the first section (18′) of the bearing gap is sealed by a conical capillary seal.

11. A fluid dynamic bearing system according to claim 1, characterized in that the first section (18′) of the bearing gap is sealed by a groove (26) provided in a shaft (12) or in a bearing bush (10).

12. A fluid dynamic bearing system according to claim 1, characterized in that the first section (18′) of the bearing gap is sealed by a pumping seal (50).

13. A fluid dynamic bearing system according to claim 1, characterized in that a thrust plate (14) is disposed in a recess in a bearing bush and is enclosed by the second section (18″) of the bearing gap, the surfaces of the thrust plate together with an opposing surface of the bearing bush (10) and/or of a cover plate (16) forming at least one axial bearing (32; 34).

14. A fluid dynamic bearing system according to claim 1, characterized in that the first section (18′) of the bearing gap has a first radial bearing (28; 38; 44) that generates a pumping effect on the bearing fluid in the direction of the second section (18″) of the bearing gap.

15. A fluid dynamic bearing system according to claim 1, characterized in that the first section (18′) of the bearing gap has a second radial bearing (40) that generates a pumping effect on the bearing fluid in the direction of the second section (18″) of the bearing gap.

16. A fluid dynamic bearing system according to claim 14, characterized in that the first section of the bearing gap has a second radial bearing (30; 46) that generates a pumping effect in the direction of the first radial bearing (28; 44).

17. A fluid dynamic bearing system according to claim 1, characterized in that a recirculation channel (42; 48) is disposed within a bearing bush (10), the recirculation channel connecting the supply volume directly to a section of the bearing gap (18) and/or a groove (26).
